(19) United States
(12) Patent Application Publication
(10) Pub. No.: US 2002/0124678 A1
(43) Pub. Date: Sep. 12, 2002

(54) Shifting device for a bicycle

(76) Inventor: Chieh-Yuan Chen, Taichung Hsien (TW)

Correspondence Address: BACON & THOMAS, PLLC, 625 Slaters Lane, 4th Floor, Alexandria, VA, 22314-1176, US

(21) Appl. No.: 09/801,800

(22) Filed: Mar. 9, 2001

(51) Int. Cl. B62K 23/06

(52) U.S. Cl. 74/502.2

(57) ABSTRACT

A bicycle shifting device comprises a fastening seat; a display piece mounted on the fastening seat and provided with a display portion; a swiveling member pivoted to the fastening seat and having a first toothed section, a second toothed section, and an indication portion; a first actuator forced by a spring force to turn along with the swiveling member; and a second actuator forced by a spring force to turn and pivoted to the fastening seat, and having an urging portion to press against the first toothed section and the second toothed section of the swiveling member; by turning the first actuator or press-releasing the second actuator, the first actuator then turned opposite direction respectively to winding or unwinding the shifting cable, and the motion of the indication portion of the swiveling member is visible through the display portion of the display piece.

### FIELD OF THE INVENTION

The present invention relates generally to a bicycle, and more particularly to a shifting device of the bicycle.

### BACKGROUND OF THE INVENTION

As shown in FIG. 1, a prior art device 9 for shifting a bicycle is provided with an engagement lever 93 and a disengagement lever 95 located between a grip 3 and a brake lever 4. The engagement lever 93 can be turned with thumb 7 of a bicyclist. A shifting cable 5 is actuated by the levers 93 and 95.

The prior art device 9 described above is defective in design in that index finger 8 of the bicyclist is susceptible to injuries at the time when the index finger presses the disengagement lever 95 and the brake lever 4 in emergency. This is due to the fact that the disengagement lever 95 is disposed between the brake lever 4 and the grip 3. The prior art device 9 is further defective in design in that the disengagement process takes place rapidly, thereby making it difficult for the bicyclist to bear the force of load changes. Moreover, the gear display mechanism of the prior art device 9 is too complicated.

### SUMMARY OF THE INVENTION

It is therefore the primary objective of the present invention to provide a shifting device for a bicycle. The device is simple in design to enable its operating parts to work with precision, thereby resulting in a correct display of the gear position.

It is another objective of the present invention to provide a shifting device for a bicycle. The device enables the shifting device to operate in a step-by-step manner so as to provide the bicyclist with a riding comfort.

It is still another objective of the present invention to provide a shifting device for a bicycle. The device is so designed as to prevent fingers of the bicyclist from being injured by the brake lever of the bicycle.

The device of the present invention comprises a fastening seat, a display piece, a swiveling member, a first actuator, and a second actuator. The fastening seat is mounted on the handgrip of a bicycle and is provided with a first pivoting portion and a second pivoting portion. The display piece is mounted on the fastening seat and is provided with a display portion. The swiveling member turns along the center of the first pivoting portion and has a first toothed section, a second toothed section, and an indication portion capable of swiveling along with the swiveling member and visible from the display portion of the display piece. The first actuator is forced by a spring force to turn along with the swiveling and is provided with a lever for controlling the rotation of the first actuator. The second actuator is forced by a spring force to turn and is fastened pivotally with the second pivoting portion of the fastening seat. The second actuator has a lever for controlling the rotation of the second actuator, and an urging portion for pressing against the first toothed section of the swiveling member to attain the shifting operation. When turning the first actuator, the urging portion of the second actuator then press against the first toothed section of the swiveling member step-by-step; but press-release the second actuator, the urging portion then orderly press against the second toothed section and the first toothed section of the swiveling member; both operation enable the first actuator to turn to winding or unwinding the shifting cable, and the motion of the indication portion of the swiveling member is visible through the display portion of the display piece.

Preferably, said fastening seat is formed of a housing seat and a lower cover.

Moreover, said first pivoting portion and said second pivoting portion of said fastening seat are respectively a pivoting pillar.

### BRIEF DESCRIPTION OF THE DRAWINGS

FIG. 1 shows a schematic view of a prior art shifting device for a bicycle.

FIG. 2 shows a perspective view of the present invention mounted on a bicycle.

FIG. 3 shows a perspective view of the present invention without a lower cover.

FIG. 4 shows an enlarged view of a portion indicated by a circle “A” as shown in FIG. 3.

FIG. 5 shows an exploded view of a preferred embodiment of the present invention.

FIG. 6 shows a bottom plan view of the present invention in operation.

FIG. 7 shows another bottom plan view of the present invention in operation.

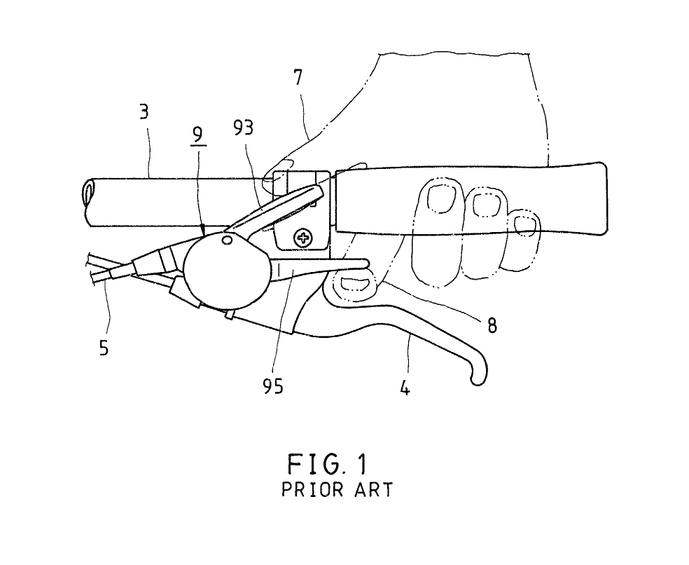

### DETAILED DESCRIPTION OF THE INVENTION

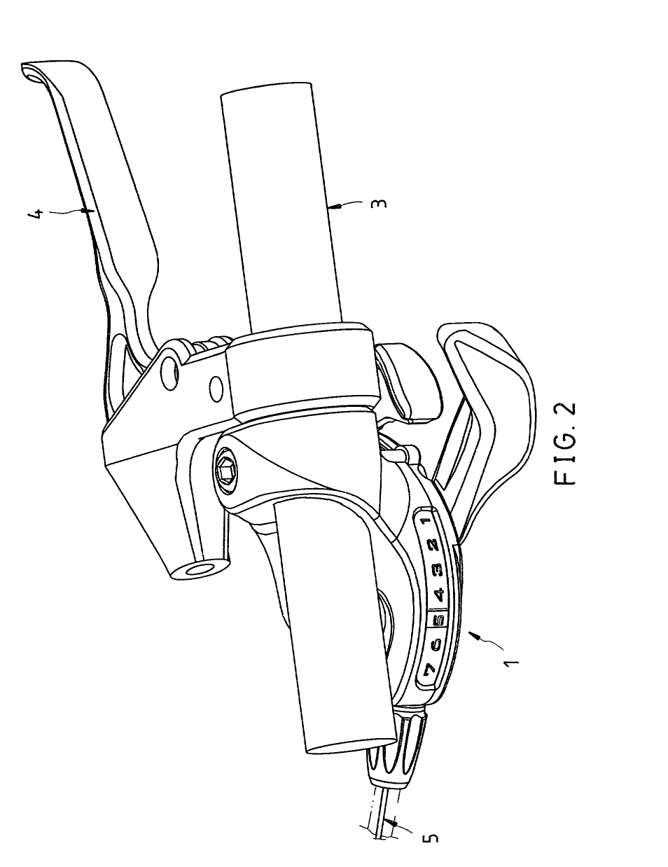

As shown in FIG. 2, a device 1 of the present invention is intended to operate a bicycle shifting device and is mounted on a grip 3 such that the device 1 is located in proximity of a brake lever 4 for actuating a shifting cable 5.

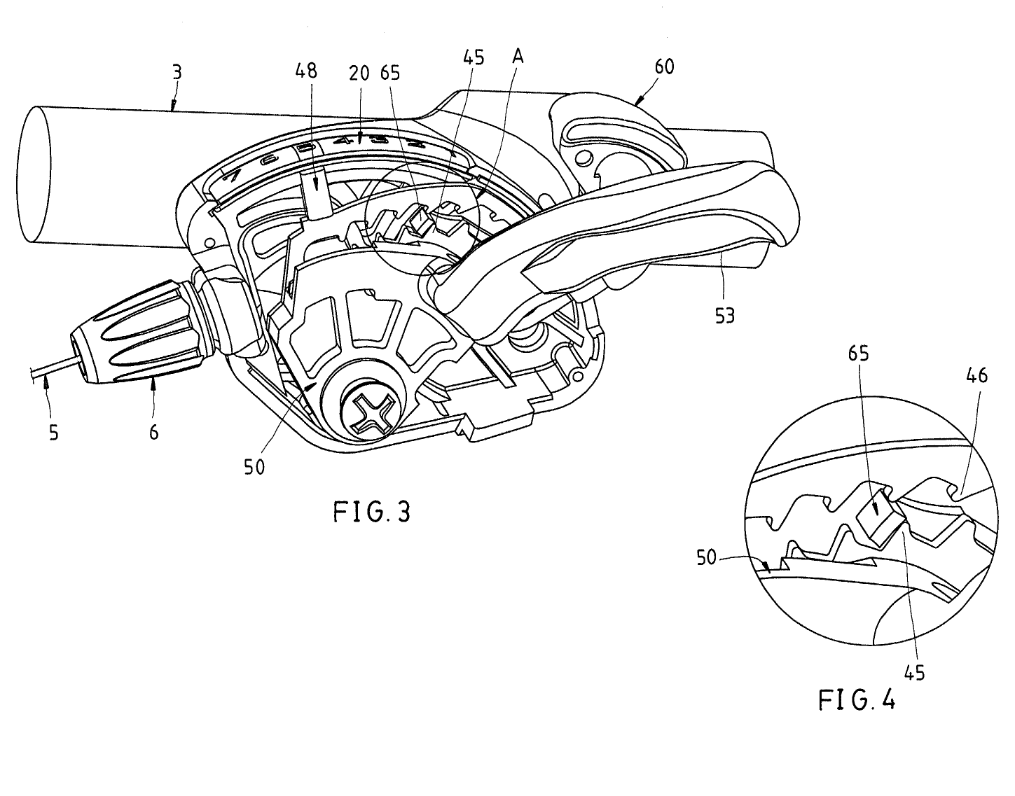

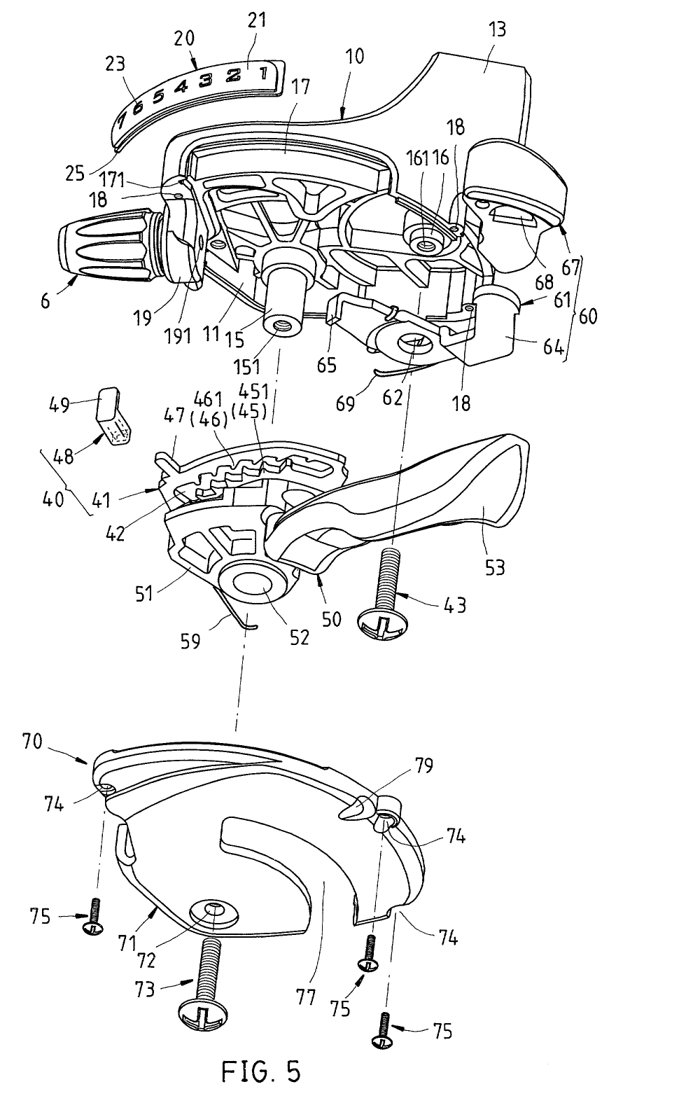

As shown in FIGS. 3-5, the device 1 of the present invention comprises component parts which are described hereinafter.

A housing seat 10 has a bottom housing 11 with an opening which faces downward, a fastening tube 13 mounted on the grip 3. The bottom housing 11 is located under the grip 3. A first pivoting pillar 15 and a second pivoting pillar 16 are mounted on the bottom housing 11 and are provided at one end with a threaded hole 151, 161 extending along the axial direction thereof, and at other end with an opening 17 which is provided with a retaining groove 171, three threaded holes 18, and a cable constrained portion 19 having at one end thereof a cable hole 191 for fastening a rotary sleeve 6.

A display piece 20 has a transparent display portion 21 with a plurality of gear position marks 23 and a mounting edge 25 which is received in the retaining groove 171 of the housing seat 10.

A swiveling member 40 is pivotally fastened with the first pivoting pillar 15 and has a plate 41 with a movable slot 42. Located in the long arcuate side in proximity of the circle center is a first toothed section 45. Located in the opposite side is a second toothed section 46. The first toothed section 45 has a plurality of continuous retaining teeth 451, whereas the second toothed section 46 has a plurality of continuous retaining teeth 461. An indication end 47 is formed on one end of the swiveling member 40 such that the indication end 47 is opposite in location to the display portion 17 of the housing seat 10. The indication end 47 is provided with an indication sleeve 48 forming an indication portion 49.

A first actuator 50 has a main body 51 which is provided with a pivoting hole 52 for fitting the first pivoting pillar 15 of the housing seat 10, thereby linking the swiveling member 40. A lever 53 is provided for turning the first actuator 50 with hand. A torsion spring 59 is disposed between the first actuator 50 and the housing seat 10 to provide a reverse turning force. The first actuator 50 is for winding and unwinding the shifting cable 5.

A second actuator 60 has a main body 61 which is provided with a pivoting hole 62 for disposing the second pivoting pillar 16 of the housing seat 10 in conjunction with a bolt 63 which is engaged with the threaded hole 161 of the second pivoting pillar 16 of the housing seat 10. A lever 64 is disposed at one end of the second actuator 60, and an urging portion 65 for pressing against the first toothed section 45 and the second toothed section 46 of the swiveling member 40 when the second actuator 60 turns. A rod sleeve 67 is provided with a fitting hole 68 for fitting the lever 64 of the main body 61. A torsion spring 69 is provided between the rod sleeve 67 and the housing seat 10 to provide a reverse turning force of the pressing direction.

A lower cover 70 has a cover body 71 which is provided with an inner hole 72 for receiving a bolt 73 which is meshed with the threaded hole 151 of the first pivoting pillar 15 of the housing seat 10. The lower cover 70 covers the opening of the bottom housing 11 of the housing seat 10 and has a plurality of fastening holes 74 for each screw 75 to be put through to engage the threaded hole 18 of the housing seat 10. An open slot 77 is intended for the displacement of the lever 53 of the first actuator 50. A cable hole 79 is intended to dispose or replace the shifting cable 5.

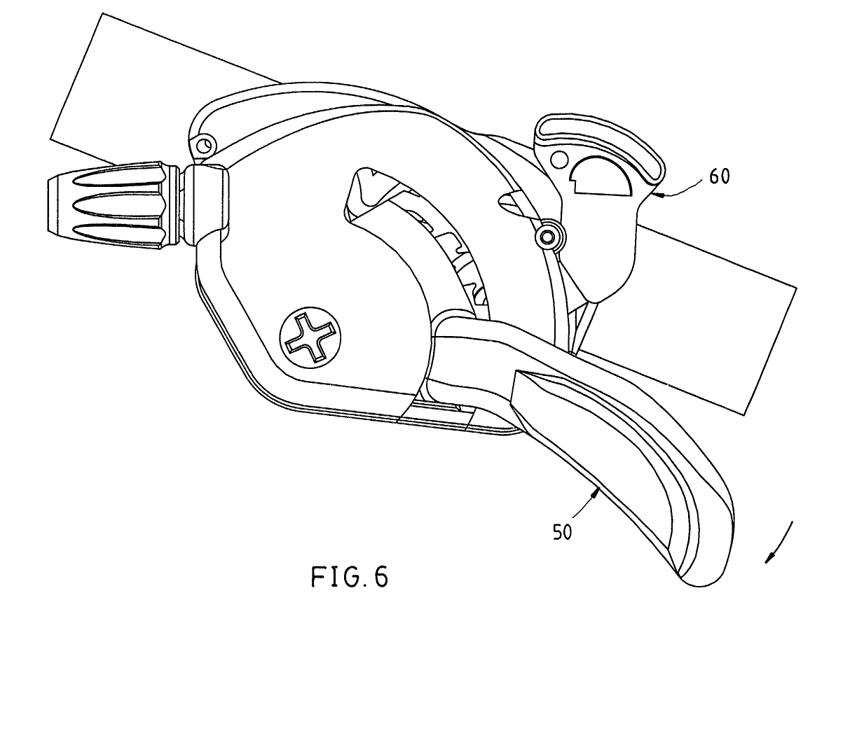

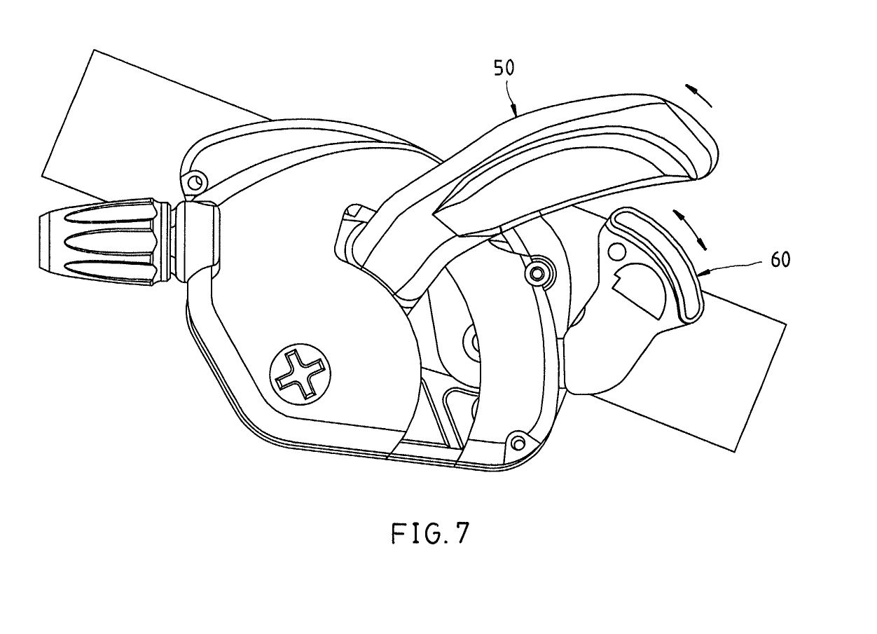

As shown in FIG. 6, the lever 53 is pressed by thumb of a bicyclist such that the first actuator 50 is turned, thereby causing the swiveling member 40 to turn such that the first toothed section 45 of the swiveling member 40 is caused to press against the urging portion 65 of the second actuator 60. As a result, the urging portion 65 of the second actuator 60 is sequentially stopped at other tooth of the first toothed section 45 of the swiveling member 40 step-by-step. Then the first actuator 50 winding the shifting cable 5.

As shown in FIG. 7, the gear disengagement is brought about by the thumb pressing the second actuator 60 so as to cause the urging portion 65 of the second actuator 60 to turn to the second toothed section 46 of the swiveling member 40, thereby releasing the second actuator 60, which is then turned in reverse by the spring force of the torsion spring 69. The urging portion 65 is then located at another adjoining tooth 451 of the first toothed section 45 of the swiveling member 40. As a result, the first actuator 50 unwinding the shifting cable 5.

Relatively, the indication sleeve 48 of the swiveling member 40 swivels along to be corresponding in location to each gear position mark 23 of the display piece 20. The shifting portion is visible to the bicyclist.

Therefore, index finger is not used to operate the device of the present invention and is therefore not vulnerable to injury by the brake lever 4 and the device 1 of the present invention.

It must be noted here that the indication portion of the swiveling member may be disposed on the first actuator. The gear position marks of the display piece may be disposed on the fastening seat. The display portion of the display piece may be a see-through hole.

The device of the present invention has advantages. In the first place, the device of the present invention simplifies the gear engagement operation and the gear disengagement operation, without interfering the operation of other device, such as the braking device. In addition, the device of the present invention is simple in design and can be provided with a simple display device to exhibit precisely the gear position.

What is claimed is:

1. A shifting device for a bicycle, said device comprising:
a fastening seat mounted on a bicycle handlebar and provided with a first pivoting portion and a second pivoting portion;
a display piece mounted on said fastening seat and provided with a display portion through which an interior of said fastening seat can be seen by a bicyclist;
a swiveling member capable of turning along the center of said first pivoting portion of said fastening seat, said swiveling member having a first toothed section, a second toothed section, and an indication portion capable of swiveling along with said swiveling member and capable of being seen through said display portion of said display piece;
a first actuator forced by a spring force to turn along with said swiveling member, said first actuator having a lever to control rotation of said first actuator, the first actuator is for winding and unwinding a shifting cable;
a second actuator pivoted to said second pivoting portion of said fastening seat such that said second actuator is forced by a spring force to turn, said second actuator having a lever to control rotation of said second actuator, and an urging portion for pressing against a predetermined portion of said first toothed section and said second toothed section of said swiveling member;
said first actuator being turned to cause said urging portion of said second actuator press against said first toothed section of said swiveling member step-by-step, thereby the first actuator winding the shifting cable; said second actuator being turned then released to enable said urging portion to press against orderly said first toothed section and said second toothed section of said swiveling member, thereby enabling said first actuator to turn to unwinding the shifting cable, and the motion of said indication portion of said swiveling member capable of being seen through said display piece.

2. The device as defined in claim 1, wherein said display portion of said display piece is a transparent body.

3. The device as defined in claim 1, wherein said display portion of said display piece is a see-through hole.

4. The device as defined in claim 1, wherein said display piece is provided with a plurality of gear position marks.

5. The device as defined in claim 2, wherein said display piece is provided with a plurality of gear position marks.

6. The device as defined in claim 3, wherein said display piece is provided with a plurality of gear position marks.

7. The device as defined in claim 1, wherein said fastening seat is provided with a plurality of gear position marks corresponding in location to said display piece.

8. The device as defined in claim 2, wherein said fastening seat is provided with a plurality of gear position marks corresponding in location to said display piece.

9. The device as defined in claim 3, wherein said fastening seat is provided with a plurality of gear position marks corresponding in location to said display piece.

10. The device as defined in claim 1, wherein said fastening seat is further provided with an opening for receiving said display piece.

11. The device as defined in claim 10, wherein said opening of said fastening seat is provided with a retaining groove for retaining said display piece.

12. The device as defined in claim 1, wherein first actuator is provided with an indication portion in place of said indication portion of said swiveling member.

13. The device as defined in claim 1, wherein said indication portion is an indication sleeve.

14. The device as defined in claim 13, wherein said indication portion is an indication sleeve.

15. The device as defined in claim 1, wherein said first pivoting portion and said second pivoting portion of said fastening seat are respectively a pivoting pillar.

16. The device as defined in claim 1, wherein said first actuator is pivotally fastened with said first pivoting portion of said fastening seat.

17. The device as defined in claim 1, wherein said swiveling member and said first actuator are made integrally.

18. The device as defined in claim 1, wherein said fastening seat is formed of a housing seat and a lower cover.

19. The device as defined in claim 18, wherein said lower cover is provided with an open slot to facilitate the swiveling of said first actuator.

20. The device as defined in claim 18, wherein said lower cover is provided with a cable hole to facilitate the disposing of a shifting cable.
